(19) United States
(12) Patent Application Publication
(10) Pub. No.: US 2007/0085235 A1
(43) Pub. Date: Apr. 19, 2007

(54) METHOD AND APPARATUS FOR CONTINUOUSLY PREPARING CROSSLINKED, SOLUTION-CAST POLYMER FILM

(76) Inventors: Timothy J. Boyle, Gary, IN (US); Alex Szopinski, Chesterton, IN (US); Andrew P. Verrall, Crown Point, IN (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/534,690

(22) Filed: Sep. 25, 2006

Related U.S. Application Data
(60) Provisional application No. 60/728,138, filed on Oct. 18, 2005.

(51) Int. Cl. B29D 7/00

(52) U.S. Cl. 264/216

(57) ABSTRACT

A method and system for continuously preparing a crosslinked, solvent-cast film are disclosed. The method includes continuously providing a pressurized stream of polymer solution, continuously combining a fluid stream including a crosslinking agent with the pressurized stream of polymer solution, mixing the combination of polymer solution and fluid stream in-line, continuously applying the resulting mixture to a continuously moving surface, and then evaporating solvent from the mixture to form a polymeric film. The system includes: (i) a continuous polymer solution casting system, including a first pump in fluid communication with a supply of polymer solution, a casting die for continuously depositing polymer solution disposed in proximity to a moving casting surface, and a first conduit providing a flow path for the polymer solution from the pump to the casting die; (ii) a secondary liquid component injection system, including a second reservoir for holding a supply of a secondary liquid component including a crosslinking agent, a variable-speed second pump in fluid communication with the supply of secondary liquid component, a needle valve, and a second conduit providing a flow path for the secondary liquid component from the reservoir, through the second pump, then through the needle valve, and to an outlet; (iii) a conduit junction connecting the outlet of the secondary liquid component injection system to the first conduit of the continuous polymer solution casting system, the junction disposed downstream of the first pump; and (iv) an in-line mixer disposed between the casting die and the conduit junction.

### CROSS-REFERENCE TO RELATED APPLICATIONS

The benefit under 35 U.S.C. §119(e) of U.S. Provisional Patent Application Ser. No. 60/728,138 filed Oct. 19, 2005, is hereby claimed.

### BACKGROUND

1. Field of the Disclosure

The disclosure relates generally to a method and apparatus for continuous solution casting of a polymer to create a film. More particularly, the disclosure relates to a method and apparatus for injecting a secondary agent, such as a cross-linking agent, into a stream of polymer solution just upstream of a casting die, for continuously producing a polymer film, such as polyvinyl alcohol, that is crosslinked.

2. Brief Description of Related Technology

Though the general technology for producing plastic materials has been used for decades, solvent-film casting is attracting increasing interest. One of the reasons is that specific requirements in the fields of water-soluble packaging and other related applications can only be met by this technology.

The development of a continuous process to manufacture thin plastic films was closely linked to the emerging photographic industry starting from the end of the 19th Century. In those times, no other technology was available for industrial film forming, and polymer science was also still in its infancy. Two different technologies were soon developed: (1) casting on wheels or large drums; and (2) casting onto endless flexible metal belts. Surprisingly, both are still in use today, together with a third technology, casting onto moving plastic films. However, since the development of extrusion technologies for the production of thermoplastic polymer films, the importance of solvent casting methods has declined. Today, solvent casting is a specific manufacturing method which is used for niche markets and films with specific and high quality requirements.

Typical solvent casting systems utilize an organic solvent such as acetone, aniline, dimethyl sulfoxide (DMSO), benzene, dimethyl formamide (DMF), methyl ethyl ketone (MEK), ethyl acetate, ethylene dichloride, toluene, tetrahydrofuran, and the like. Such solvents usually necessitate a complex solvent vapor recovery and rehabilitation system. Further, human and environmental exposure to these solvents is most undesirable. Use of water as the primary solvent can overcome these disadvantages. No recovery and rehabilitation system is therefore necessary, and environmental and human exposure is not an issue.

There are many other processes for the formation of films, including calendering, extrusion, plastisol cast systems, and organosol cast systems. Extrusion and calendering are processes which melt the polymer and shape the plastic prior to freezing. Plastisol and organosol casting processes involve the melting of the polymer in a plasticizer matrix, after which the solvent action of the plasticizer forms a film.

In prior methods and apparatus, the solution that is eventually cast onto a moving surface, containing the base polymer and secondary components such as plasticizers, fillers, surfactants, actives, and colorants, is prepared by combining the base polymer and secondary components with water in a tank and then mixing. The homogeneous solution or suspension is then pumped through one or more operations including de-aeration and filtering and then fed to a solution casting die for casting onto the moving surface, such as a traveling belt.

Polyvinyl alcohol (PVOH) membranes have been proven useful in desalination, separation of organic solvents and phenols from water, ion exchange, as battery separators, and in biomedical applications. PVOH is a good candidate for a membrane because it is easily processable, exhibits high mechanical stability, and is non-toxic. Since PVOH is highly hydrophilic, unmodified membranes become highly swollen in water. Previously, PVOH membranes have been modified by various methods, such as batch chemical methods, irradiation, and heat-treatment. On the macro scale, thickness, pore structure and crosslinking type of the PVOH membrane are found to influence solvent transport.

### SUMMARY

One aspect of the disclosure provides a method for continuously preparing a solvent cast film having a secondary component, including continuously providing a pressurized stream of polymer solution, combining a fluid stream including a crosslinking agent with the pressurized stream of polymer solution, mixing the combination of polymer solution and fluid stream in-line, continuously applying the resulting homogeneous mixture of polymer solution and crosslinking agent to a moving surface, and then evaporating solvent from the mixture.

Another aspect of the disclosure provides an improved method of casting a polymer solution including a crosslinking agent onto a substrate for evaporating off a solvent and forming a crosslinked film, the improvement including continuously injecting the crosslinking agent into a stream of polymer solution, mixing the resulting stream of polymer solution with the crosslinking agent in-line, and then casting the resulting polymer solution onto a moving substrate to continuously produce crosslinked film.

Further aspects and advantages will be apparent to those of ordinary skill in the art from a review of the following detailed description, taken in conjunction with the drawings. While the method, system, and improvement are susceptible of embodiments in various forms, the description hereafter includes specific embodiments with the understanding that the disclosure is illustrative, and is not intended to limit the invention to the specific embodiments described herein.

### BRIEF DESCRIPTION OF THE DRAWINGS

For further facilitating the understanding of the present invention, five drawing figures are appended hereto, wherein:

FIG. 1 shows and example of a system for solvent casting according to the disclosure;

FIG. 2 shows an embodiment of an adjustable sheeting die for casting polymer solution;

FIG. 3 shows an example of the relationship between drums and a band in a basic band casting machine;

FIG. 4 (elevation view) and 5 (plan view) show an embodiment of an injection system and associated feed and in-line mixing components.

### DETAILED DESCRIPTION

The invention generally relates to a method and apparatus for solution casting to continuously form a polymer film that includes one or more secondary components.

The solution cast process offers several unique features which conventional fusion processes lack. In solvent casting, film formation depends upon solubility, not melting. Thus, a wide range of polymeric alloys can be produced by solvent casting. Because the flowability to form a film is provided by the solvent, a pure resin film can be manufactured without adulteration by heat, stabilizers, plasticizers, or lubricants. Only additives which are beneficial to the finished product need to be incorporated with the polymer.

Solvent casting can provide a film which has excellent dimensional stability as well as reduction in or freedom from pinholes, gels and other imperfections. Due to the very low heat history which is inherent in a film produced by solvent casting processing, the process can also provide an extended service life to the film.

The method generally involves the steps of continuously pumping a feed of polymer solution towards a casting surface, continuously combining one or more secondary components with the feed of polymer solution, mixing the combination, and then depositing the combined solution onto the casting surface. Preferably, the secondary component includes a crosslinking agent.

Prior methods and systems for producing crosslinked films, particularly crosslinked PVOH, were performed batchwise. In the method described herein, one or more crosslinking agents are continuously injected into a stream including the base polymer in solution prior to film formation and crosslinking. Among the benefits which can be achieved by various embodiments of the method and system is the benefit of flexibility and efficiency in creating different types of film by more efficiently changing the film formulation and preparing the system for production of a new formulation, in continuous production of crosslinked film, and in consistency of product quality.

In one embodiment, the method involves continuously providing a pressurized stream of polymer solution, continuously combining a fluid stream including a secondary component with the pressurized feed of polymer solution, homogeneously mixing the combination of polymer solution and fluid stream in-line, continuously applying the resulting homogeneous mixture of polymer solution and secondary component to a continuously moving surface, and then evaporating solvent from the mixture to form a polymeric film. When the secondary component includes a crosslinking agent, the crosslinking begins upon introduction of the crosslinking agent into the polymer solution, and may continue after film formation and even after the product film is removed from the casting surface and collected (e.g., wound onto a roll).

The polymer solution is any substantially homogeneous mixture of a polymer in a suitable solvent. The term “polymer solution” is used herein to refer to such a solution prior to continuous injection of a secondary component as described herein, except when stated otherwise. The disclosed method and system is ideally suited for a water-soluble polymer, such as polyvinyl alcohol (PVOH), dissolved in water. The water content of the PVOH solution is preferably within the range of from about 60% by weight to about 85% by weight. Suitable water-soluble materials include, but are not limited to polymers, copolymers and derivatives thereof.

For example, the water-soluble material can include a polymer selected from the following group, including water-soluble copolymers and other derivatives thereof, and mixtures thereof: polyvinyl alcohols, polyethylene oxides, dextrans, starches, cellulose derivatives (eg., hydroxyethyl cellulose, hydroxypropyl cellulose, and other cellulose ethers), polyvinylpyrrolidone, polyacrylamide, polyacrylic acid, polyacrylates, pectin, alginates, proteins and derivatized proteins (e.g., gelatin, corn zein, whey protein).

While other polymer solutions are suitable for use with the disclosed system, the description of the embodiments herein is made with specific reference to the manufacture of crosslinked PVOH film.

If polyvinyl alcohol or a copolymer thereof is used, then the PVOH can be partially or fully hydrolyzed. Polyvinyl alcohol (PVOH) is a synthetic resin generally prepared by the alcoholysis, usually termed hydrolysis or saponification, of polyvinyl acetate.

Fully hydrolyzed PVOH, where virtually all the acetate groups have been converted to alcohol groups (e.g., 98% or greater degree of hydrolysis), is a strongly hydrogen-bonded, highly crystalline polymer which dissolves only in hot water—e.g., rapid dissolution at temperatures of about 60° C. and greater.

If a sufficient number of acetate groups are allowed to remain after the hydrolysis of polyvinyl acetate, the PVOH polymer then being known as partially hydrolyzed, it is more weakly hydrogen-bonded and less crystalline and is soluble in cold water—e.g., rapid dissolution at temperatures of about 10° C. and greater.

Both fully and partially hydrolyzed PVOH types are commonly referred to as PVOH homopolymers although the partially hydrolyzed type is technically a vinyl alcohol-vinyl acetate copolymer.

Because there are so many chemically different types of products that can be made from water-soluble films, the polymer solutions must be formulated in different ways. That is, a PVOH resin, crosslinking agent, plasticizer system and other ingredients can vary and can provide a range of films with different product characteristics, from a highly water-swellable hydrogel-type film to a rigid membrane film.

“Water soluble” refers to a film which, when exposed to water, begins to dissolve or disintegrate to its smallest components. Polyvinyl alcohol (PVOH) is a hydrophilic polymer and the plasticizers typically used in its manufacture also have an affinity for water. PVOH will absorb moisture from a wet atmosphere and give up moisture to a dry atmosphere. As moisture content increases (even with humidity), a PVOH film will tend to quickly become softer and more elastic, losing tensile properties and increasing in ultimate elongation. Also, the coefficient of friction of a PVOH film will increase with increased moisture content.

The polymer solution can consist of or consist essentially of solvent(s) and base polymer resin(s), with one or more crosslinking agents and optional secondary agents injected into a stream of the polymer solution before application to the surface on which the film is formed. In another embodiment, the polymer solution can include common processing aids that would find utility in a wide variety of formulations, such as plasticizers, lubricants, release agents, fillers, extenders, antiblocking agents, detackifying agents, antifoams and other functional or decorative ingredients, in amounts suitable for their intended purpose, and one or more crosslinking agents are injected into a polymer solution feed stream and then mixed, before application to the surface on which the film is formed.

For PVOH as the water-soluble polymer, the crosslinking agent may be any chemical agent that can form chemical bonds with the hydroxyl groups of PVOH.

Such crosslinking agents include, but are not limited to, monoaldehydes (e.g., formaldehydes, hydroxyacetaldehydes, and hydroxyadipaldehydes), dialdehydes (e.g., glyoxal, glutaraldehyde and succinic dialdehyde), aldehyde-containing resins (e.g., trimethylol melamine, melamine formaledehyde), polyfunctional carboxylic acids (e.g., dicarboxylic acids such as maleic, oxalic, malonic and succinic acids), citric acid, glycidyl and other difunctional methacrylates, N-lactam carboxylates, dithiols (e.g., m-benzodithiol), urea-formaldehyde and melamineformaldehyde, dimethyl urea, di-isocyanates, boric acid and borates, salts of multivalent anions (e.g., ammonium zirconium carbonate), inorganic polyions (e.g., molybdate and tungstate), cupric salts and other Group 1B salts, polyamide-epichlorohydrin resin (polyazetidine prepolymer), and combinations of any of the foregoing. In one embodiment of the method, a dialdehyde (e.g., glyoxal, glutaraldehyde, or both) is preferred.

Some crosslinking agents undergo direct condensation reactions with hydroxyl groups to form covalent bonds (such as esterification and acetalization reactions with carboxylic acids and aldehydes, respectively). Other crosslinking agents can have one or more of the following functionalities: those that form complexes via labile polar covalent interactions, those that crosslink via ionic interactions, those that crosslink via hydrogen bonding interactions, and combinations of such crosslinking agents. All such types of crosslinking agents are contemplated for use in the method described herein. An example of a water-soluble polyamide-epichlorohydrin is available under the trade name POLYCUP 172 by Hercules, Inc. of Wilmington, Del.

The foregoing crosslinking agents are particularly suitable for polyvinyl alcohol and many of the other water-soluble polymers described herein, but other crosslinking agents may be more appropriate or convenient for others of the described water-soluble polymers, and still other crosslinking agents may be more appropriate or convenient for other polymers which can be solution-cast and crosslinked. For example, alginates are very conveniently crosslinked by simple calcium salts. Furthermore, as it is known in the art, various crosslinking agents are used with a catalyst, such as an acid catalyst with an aldehyde crosslinker.

The crosslinking agent preferably is present in an amount up to about 10% by weight, for example about 1% to about 10% by weight, or 5% to about 10% by weight, based on the weight of the water-soluble polymer. For example, water-soluble polyamide-epichlorohydrin preferably is used in an amount of about 7-10% by weight of a PVOH polymer. As another example, boric acid is preferably used in an amount of about 5% by weight of a PVOH polymer.

Other secondary components can be colorants, such as those soluble in the polymer solution (e.g., an acid dye, direct dye, basic dye, other water-soluble dye, or any combination thereof) and/or those insoluble in the polymer solution.

In another embodiment, it is contemplated that the secondary component will be an insoluble particulate. For example, a particulate can be used to impart a desired decorative appearance to the resulting film. Accordingly, particulates that have one or more properties such as coloration, reflectivity, fluorescence, translucence, opalescence, pearlescence, and the like, are suitable. Insoluble pigments are one type of particulate matter contemplated. The particulates can have any morphology, including spherical, crystalline, irregular, and planar.

In another embodiment, it is contemplated that the secondary component will be a soluble particulate. For example, a shaving or flake of colored water-soluble material (e.g., PVOH or gum arabic) can be used, and can be completely dissolved by the time of casting to provide the resulting film with a tinted or colored film, or it can be partially dissolved by the time of casting to provide the film with a non-homogenous appearance. In another example, microcapsules can be used as a secondary component. Thus, a microcapsule with a relatively soft shell (e.g., gelatin) can be introduced and sheared in the mixing step to release color or another agent (e.g., scent, crosslinking agent) into the polymer mixture. The degree and timing of shear before casting can be used to control the characteristics of the resulting film. A color-containing microcapsule with a relatively rigid shell (e.g., gelatin with a degree of crosslinking) can be used to introduce color into the polymer solution and provide the resulting film with a non-homogeneous appearance. Water-soluble microcapsules or microspheres are preferably slurried in a non-aqueous carrier (e.g., a glycol) prior to injection into an aqueous polymer solution.

In one embodiment, the particulates will have an average particle size of 1 micron to 100 microns. In another embodiment, the particulates will have an average particle size of 4 microns to 25 microns. The solids content of the insoluble particulate secondary component in a fluid injected into the polymer solution preferably is in a range of about 3% by weight, based on the total weight of the polymer solution (wt. %) to about 10 wt. %. Other secondary agents can be selected from among plasticizers, lubricants, release agents, fillers, extenders, antiblocking agents, detackifying agents, antifoams and other functional or decorative ingredients, and combinations of any of the foregoing.

The fluid stream which includes the secondary component can take any desired form, such as, but not limited to, a solution, a suspension, an emulsion, a sol, and a gel.

The secondary component will typically be present in the fluid in a much greater concentration than will be desired in the ultimate film product, resulting in a relatively low flow rate of fluid injection. Accordingly, the fluid including the secondary component will typically be injected into the polymer solution stream in a relatively low ratio of secondary component to polymer solution. For example, the ratio can be about 1:10 to about 1:100 by volume of secondary component to polymer solution, such as with a water-soluble dye. For a crosslinking agent, the ratio of crosslinking agent to polymer solution can be about 0.3:10 to about 0.3:100, for example. In one type of embodiment, the flow rate of fluid containing the secondary component will be on the order of liters or tens of liters per hour whereas the flow rate of polymer solution is on the order of hundreds of liters per hour. For example, the flow rate of fluid containing a soluble dye as a secondary component can be in a range of about 0.5 gal./hr (2 l/hr) to about 5 gal./hr (19 l/hr) when the flow rate of polymer solution is about 100 gal/hr (379 l/hr).

The fluid stream preferably has a sufficient viscosity such that its volumetric flow rate can be accurately measured. In one embodiment, it is contemplated that the viscosity of the fluid stream containing the secondary component will be at least 30 cps at 185° F. (85° C.), for example about 70 cps to about 80 cps at 185° F. (85° C.). It is contemplated that the fluid can include a glycol, such as propylene glycol, to adjust the viscosity to the desired range, for example when the secondary component is water-soluble, such as a water-soluble dye.

In contrast to the fluid containing the secondary component, the polymer solution will typically have a relatively high viscosity and solids content. For example, the polymer solution can have a solids content of at least about 20 wt. %, or about 25 wt. % to about 40 wt. %. The viscosity can be, for example, at least 30,000 cps at 185° F. (85° C.), for example about 40,000 cps to about 50,000 cps at 185° F. (85° C.).

In a die casting method, the pressure of the supplied polymer solution will typically be relatively high, such as at least 100 psi (0.7 MPa), or about 100 psi to about 200 psi (about 0.7 MPa to about 1.4 MPa). In one embodiment of the method and system described herein, the fluid containing the secondary component is pressurized to exceed the polymer solution stream pressure at the point of injection, in order to accurately and reliably inject the secondary component into such a pressurized polymer solution stream. The degree of overpressure is preferably at least 120% (e.g., 120 psi (0.8 MPa) for a polymer solution pressure of 100 psi (0.7 MPa)).

The method can be performed by any suitable apparatus, such as a band casting system, a particular embodiment of which will now be described in connection with the figures. A preferred embodiment of a band casting system includes a mixing system, a band casting machine comprising at least first and second rotating drums about which a continuous metal band is tensioned and travels with the rotation of the drums, a polymer applicator such as an adjustable sheeting die or other device used for applying the polymer solution from the tank to the metal band, and a drying chamber enclosing a least a portion of the metal band downline of the sheeting die.

The overall solvent casting system is generally referenced by the number “10.” Other components are similarly and consistently numbered throughout the specification and drawings. While some embodiments disclosed herein are described for use with a particular continuous band casting machine, such as, for example, those designed and manufactured by Berndorf Belt Systems, Inc. of Carpentersville, Ill., other such band casting machines are be capable of adaptation for implementation of the described method and apparatus.

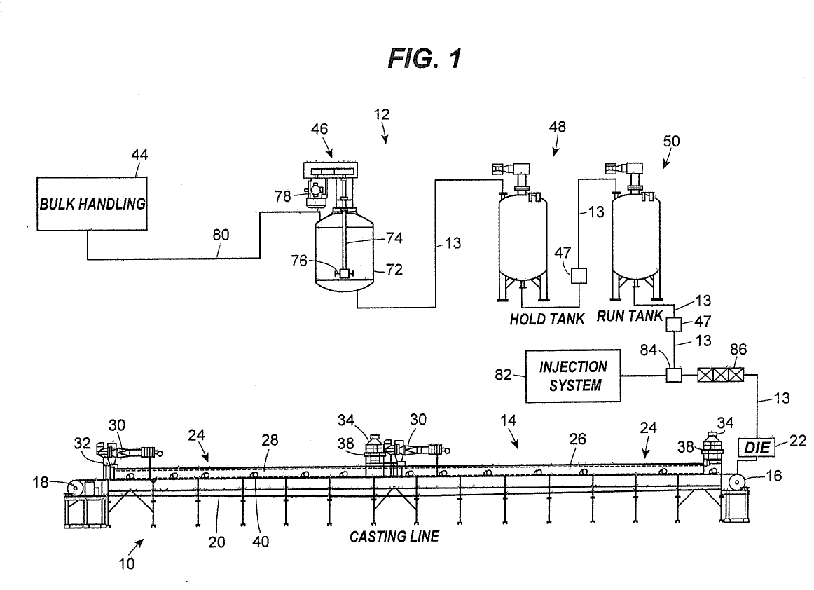

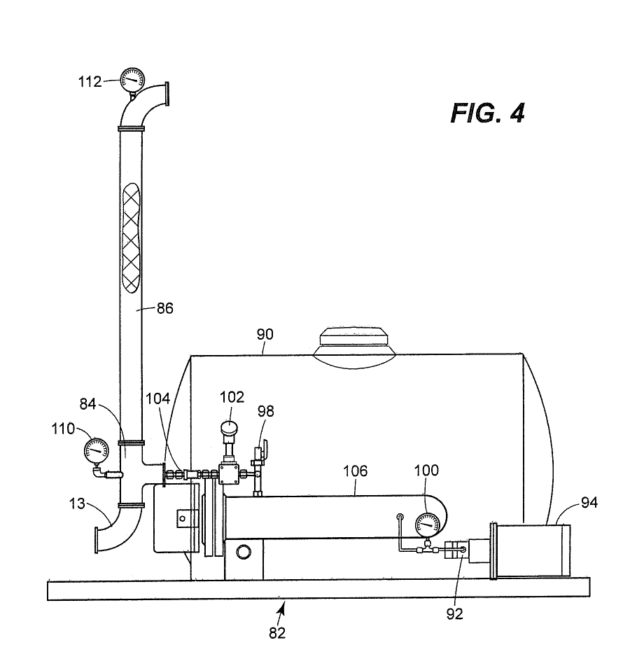

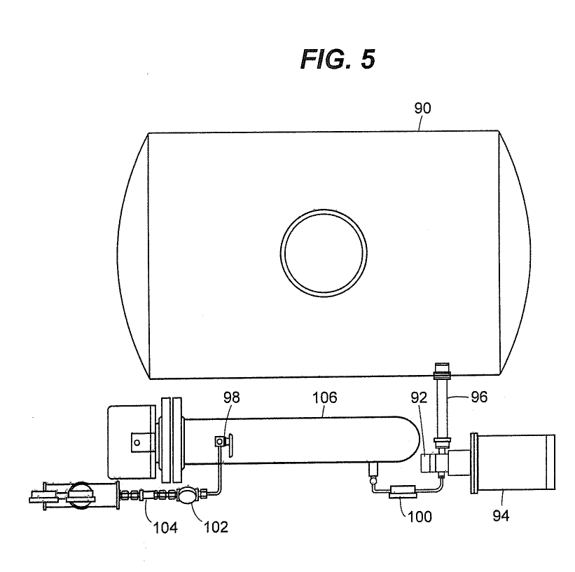

The general components of a system for solvent casting according to the disclosure can be described with reference to FIG. 1. The embodiment of a solvent band casting system 10 begins with a mixing system 12 for mixing and storing a polymer solution. The mixing system 12 can be a single tank, or in a preferred embodiment may comprise a plurality of tanks and attendant piping, pumps, and valves to control the flow of the polymer solution among the tanks. Proximate the mixing system 12, a band casting machine 14 is shown including first and second rotating drums 16 and 18, respectively, about which a continuous loop of metal band 20 is tensioned and travels with the rotation of the drums 16, 18. Between the mixing system 12 and casting machine 14 is shown an injection system 82 (shown schematically) coupled to a polymer solution feed line 13 by a conduit junction 84. Downstream of the junction 84 is an in-line mixer 86 (shown schematically in FIG. 1 and in cut-away view as a static mixer in FIG. 4), disposed just prior to the casting die 22. The conduit junction 84 can be a manifold, with a plurality of associated injection systems 82 for a plurality of secondary components or component mixtures, each of such components or component mixtures independently added to the polymer solution feed. A plurality of secondary components can also be injected at various points along the polymer solution feed system (e.g., as measured by distance from the applicator such as a casting die), due to potential effects on viscosity, component interactions, and targeted characteristics of the product film desired.

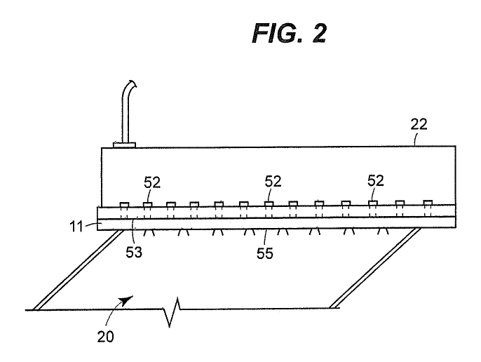

A coating device such as a casting die 22 (e.g., a sheeting die) is used to apply the polymer solution to the metal band 20 of the casting machine 14. A feed line 13 connects the mixing system 12 and injection system 82 to the die 22 and is used to feed the polymer solution from the mixing system 12, through the various optional components and operations, and to the die 22. The die 22 (see FIG. 2) comprises an internal chamber (not shown) and a slot-shaped orifice 11 extending across the width of the die 22. The gap (e.g., determined by an adjustable vertical dimension) of the orifice 11 is variable across the width of the die 22 and is used to assist in controlling the thickness of the film produced by the casting system 10. The gap can be monitored and/or adjusted.

A drying chamber 24 is shown enclosing a portion of the loop of metal band 20 downline of the sheeting die 22. The drying chamber 24 of the embodiment shown comprises an upline zone 26 and a downline zone 28. Each zone 26, 28 includes a heater (burner) 30 located near an air inlet 32 and an exhaust blower 34 located near an air outlet 38. The portion of the metal band 20 within the drying chamber 24 at any given time, travels over and is supported by a series of support rollers or idlers 40. The embodiment shown in FIG. 1 includes a series of idlers 40 representing the combination of idlers and associated sensors for monitoring rotation of the idlers.

Film is removed at the end drum (tail drum) 18.

In the embodiment shown, the base polymer solution is first mixed in a batch operation. The mixing takes place in the mixing system 12 (see FIG. 1). In the embodiment shown, the mixing system 12 includes a bulk handling station 44, a mixer 46 having a mix tank 72, a hold tank 48 and a run tank 50. The bulk handling station 44 (shown schematically in FIG. 1) is used for holding at least the polymer raw ingredient for the desired solution, and may include other, secondary components. These ingredients can include various resins, polymers, plasticizers, and other additives. Accordingly, the bulk handling station 44 can include a number of vessels or tanks, each corresponding to one or more different ingredients. Each of the tanks or vessels is in flow communication with the mixer 46 for transporting the desired ingredients into the mix tank 72. Additionally, the various ingredients may be manually fed into the mix tank 72.

The mixer 46 includes a jacketed mix tank 72. The mixer 46 also includes a mix motor 78, a mixer shaft 74 and a plurality of mixing blades 76. The various mixing blades 76 on the mix shaft 74 provide a combination of high shear mixing and vertical movement of the solution to promote mixing. The mix shaft 74 and blades 76 are centrally located within the housing and are operably connected to the mix motor 78. Preferably, the motor 78 is a powerful one of at least about 150 horsepower. A suitable motor can be obtained from Morehouse-Cowles of Fullerton, Calif. The means of delivering the ingredients to the mix tank 72 and means of delivery of the solution can include conduits such as piping 80 and 13, respectively, between source and destination in combination with various pumps, as will be apparent to those of ordinary skill in the art.

The batch mixing process begins by filling or charging the mix tank 72 with water and a variety of components that can include plasticizers, flatting agents, surfactants, and the like. These ingredients may need to be added at different moments of the mixing process due to their potential affect on viscosity, interactions, and targeted characteristic of the product desired. The quantity of water can affect both the mixing process as well as the quality of the product produced. Temperature of the solution or suspension is maintained within a controlled range to promote efficient dispersion of the resin. The polymer resin is then added under rapid agitation effected by the mixing blades 76. Varying amounts of water may be added throughout the resin addition to assist in the mixing process.

After the resin has been added, the tank temperature set point is adjusted to accelerate dissolution of the resin. As the resin dissolves, viscosity will typically increase, making it necessary to increase the speed of the mix motor 78 to maintain adequate solution movement without causing damage to the solution or mix tank 72.

The amount of time required to produce a batch of mixed solution depends on the size of the batch and the type of resin. The mixed batch of polymer solution is then pumped out of the mix tank 72 to a hold tank 48 or a run tank 50, but typically to a hold tank 48.

The hold tank 48 is typically used to hold the solution to allow bubbles (e.g., air bubbles) and other imperfections (such as gels or affects due to temperature variation) to rise to the top and be separated from the solution. This preferably occurs while the solution is undergoing mild agitation to maintain the solution. Typically, the hold tank 48 is maintained at a temperature of 185° F. (85° C.) through use of a water or steam jacket to prevent coagulation. Other heating methods are acceptable. An agitator or stirrer (not shown) may also help minimize coagulation of the solution and maintain uniform temperature throughout the tank. Both the temperature and the agitation preferably are monitored and controlled by the controller 36. A feed line 13 runs from the hold tank 48 to the run tank 50, from where solution is continuously pumped to the die 22 for casting onto the band 20. One or more filters 47 may be placed between the hold tank 48 and the run tank 50, between the run tank 50 and the junction 84, between the junction 84 and the die 22, or in a plurality of such locations. When the secondary component includes an insoluble particulate, then preferably a filter is not disposed between the junction 84 and the die 22.

An embodiment of the injection system and associated feed and mixing components is shown in FIGS. 4 (elevation view) and 5 (plan view). The injection system includes a reservoir tank 90 for holding a supply of fluid containing secondary component. When the fluid containing the secondary component would tend to become non-homogeneous in the reservoir tank 90 (e.g., pigment settling or separation of an emulsion), then the tank can include an associated agitator or mixer (e.g., a stirrer, in-tank eductor, or any other suitable mixer; not illustrated).

A positive displacement gear pump 92 and associated A/C motor 94 with a variable frequency drive (not illustrated) feed the fluid from the tank 90 via feed line conduit 96. In embodiments wherein accurate control over the fluid injection rate is not required, other types of pumps can be used, such as a peristaltic pump. A needle valve 98 is disposed in the fluid path between the pump 92 and the junction 84 with the polymer solution feed line conduit 13 to control the fluid pressure.

The illustrated injection system 82 also includes various optional components. Fluid pressure is monitored with gauge 100. The embodiment of the system shown includes a volumetric gear flow meter 102 and a check valve 104 disposed between the needle valve 98 and the junction 84.

With certain embodiments, it may be desirable to heat the fluid containing the secondary component before injection and combination with the polymer solution. Accordingly, the injection system 82 is shown with a heater 106 disposed between the pressure gauge 100 and the needle valve 98.

Polymer solution pressure at the point of injection is monitored by gauge 110, and downstream pressure after the in-line mixer 86 is monitored by gauge 112. The in-line mixer 86 preferably is a static mixer, and can be of any desired length to provide homogeneous mixing of the polymer solution and secondary component.

In a preferred control scheme, the pressure of the fluid supply is adjusted by manually adjusting the needle valve 98 to an amount of approximately 120% of the polymer solution pressure, and then a controller (e.g., a proportional, integral, derivative controller) is used to regulate the fluid flow rate to a desired setpoint. For example, a PID feedback loop can be established by monitoring fluid volumetric flow rate with the gear flow meter 102 and controlling the speed of the pump motor 94 to achieve a desired fluid volumetric flow rate setpoint.

In an alternative control scheme, the volumetric flow rate of the polymer stream can be measured upstream and downstream of the junction 84, and the pump motor 94 speed can be adjusted to achieve the desired difference between the flow rates.

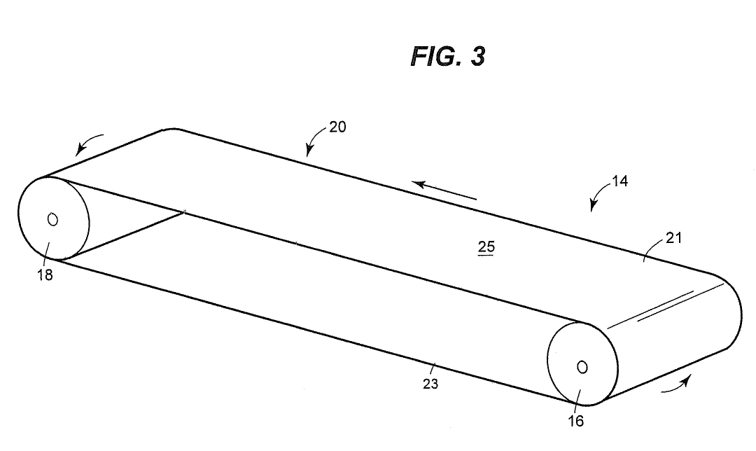

The band casting machine 14 is further understood with reference to FIG. 3. The casting machine 14 is comprised of a first or lead drum 16 and a second or end drum 18. Extending about lead drum 16 and end drum 18 is a continuous loop of metal band 20. The drums 16 and 18 travel in the direction indicated by the arrows, imposing a similar revolution of the band 20. In a preferred embodiment, the drums are approximately 65 inches wide and 48 inches in diameter, and the band 20 is approximately 61 inches wide with a circumference of approximately 325 feet. A suitable band casting machine is available from Berndorf Belt Systems, Inc. of Carpentersville, Ill.

The first or lead drum 16 is preferably hollow to allow for pre-heating the band 20 prior to coating with or casting the polymer solution. The second or end drum 18 is preferably cooled to assist removal of the final film product.

As shown in FIG. 3, the loop of metal band 20 has a production or upper portion 21 and a return or under portion 23. The outer surface 25 of the band is used to support the applied polymer solution during drying. A plurality of idlers 40 (see FIG. 1) may be spaced along the underside of upper portion of the band 20 to provide support of the band 20. The idlers 40 may also be monitored (e.g., by position sensors for monitoring rotation), to determine movement of the band 20. As the band 20 can be a very expensive piece of equipment, any complications of production which might tend to damage the band 20, such as an idler that stops rotating (e.g., resulting in the band being dragged across the idler or guiding the band off the edge of the drums 16, 18) can be avoided by monitoring and taking appropriate control action.

For casting a PVOH solution, the band 20 will typically travel from a temperature of about 125° F. (52° C.) at the lead drum 16 to a temperature of about 215° F. (102° C.) at the end drum 18. These temperature changes can affect the tracking of the band 20 on drums 16 and 18. As the dimensions of the band 20 change—even incrementally due to heating or cooling—the band 20 can begin to run off one end of a drum. Accordingly, the band preferably is made of stainless steel to address the varying thermal gradient of the system existing between the lead drum 16 and the end drum 18. Other metals, alloys, plastics, or rubbers, having desired thermal expansion parameters may also be suitable for construction of a casting band 20.

The process of solvent casting occurs with application of a layer of polymer solution onto the band surface 25. This is accomplished by the use of polymer solution applicator such as a sheeting die 22 or other coating device. A suitable die 22 is commercially available from Extrusion Dies Inc. of Chippewa, Falls, Wis. or Cloeren Incorporated of Orange, Tex. The sheeting die 22 coats (deposits) a continuous curtain of polymer solution across the width of the band 20. The die 22 (see FIG. 2) includes an internal channel (not shown) through which the solution flows. At the end of the channel is a slot-shaped orifice 11 which extends across the width of the die 22. An upper surface of the slot is formed by a lip 53 and is deformable with respect to a lower surface 55 of the slot to allow for changes to be made to the dimensions of the slot opening 11. A series of threaded bolts 52 across the width of the die are used to vary the dimensions of the slot opening depending upon the direction of rotation of the bolts. Additionally, the bolts 52 may be heated or cooled to control the thickness of the slot 11. The controlled expansion and contraction of the bolts can vary the dimensions of the slot 11. Some of the parameters which affect the film quality and thickness can be addressed at the die, including the die gap, die pressure, and angle of incidence to the band surface. Those skilled in the art are readily able to make the proper adjustments to achieve a desired film quality and thickness. A sheeting die is the preferred embodiment, however other devices may be used to apply the polymer solution to the band surface.

The foregoing description is given for clearness of understanding only, and no unnecessary limitations should be understood therefrom, as modifications within the scope of the invention may be apparent to those having ordinary skill in the art.

Throughout the specification, where compositions are described as including components or materials, it is contemplated that the compositions can also consist essentially of, or consist of, any combination of the recited components or materials, unless described otherwise.

The practice of a method disclosed herein, and individual steps thereof, can be performed manually and/or with the aid of electronic equipment. Although processes have been described with reference to particular embodiments, a person of ordinary skill in the art will readily appreciate that other ways of performing the acts associated with the methods may be used. For example, the order of various of the steps may be changed without departing from the scope or spirit of the method. In addition, some of the individual steps can be combined, omitted, or further subdivided into additional steps.

1. A method of continuously preparing a crosslinked, solvent-cast film, comprising the steps of:
continuously providing a pressurized stream of polymer solution;
continuously combining a fluid stream comprising a crosslinking agent with said pressurized stream of polymer solution;
mixing said combination of polymer solution and said fluid stream comprising a crosslinking agent in-line;
continuously applying the resulting homogeneous mixture of polymer solution and crosslinking agent to a continuously moving surface; and then
evaporating solvent from the applied mixture to form a crosslinked polymeric film.

2. The method according to claim 1, wherein the polymer solution comprises a water-soluble polymer and water as a solvent.

3. The method according to claim 2, wherein the polymer solution comprises a polymer selected from the group consisting of polyvinyl alcohol, copolymers thereof, and mixtures of the foregoing.

4. The method according to claim 3, wherein the polymer solution comprises polyvinyl alcohol.

5. The method according to claim 1, wherein the crosslinking agent is selected from the group consisting of aldehydes, aldehyde-containing resins, polyfunctional carboxylic acids, difunctional methacrylates, N-lactam carboxylates, dithiols, dimethyl urea, di-isocyanates, borates, salts of multivalent anions, inorganic polyions, Group 1B salts, polyamide-epichlorohydrin resin, and combinations thereof.

6. The method according to claim 5, wherein the crosslinking agent is selected from the group consisting of aldehydes, aldehyde-containing resins, dicarboxylic acids, and combinations thereof.

7. The method according to claim 6, wherein the crosslinking agent comprises an aldehyde.

8. The method according to claim 7, wherein the crosslinking agent comprises a dialdehyde.

9. The method according to claim 8, wherein the crosslinking agent comprises glyoxal, glutaraldehyde, or a mixture thereof.

10. The method according to claim 1, wherein the crosslinking agent is present in an amount up to about 10% by weight based on the weight of the polymer.

11. The method according to claim 10, wherein the crosslinking agent is present in an amount in a range of about 5% to 10% by weight, based on the weight of the polymer.

12. The method according to claim 1, wherein the fluid stream further comprises a glycol.

13. The method according to claim 12, wherein the glycol is propylene glycol.

14. The method according to claim 1, wherein the fluid stream has a viscosity of at least about 30 cps at 185° F.

15. The method according to claim 14, wherein the fluid stream has a viscosity of about 70 cps to about 80 cps at 185° F.

16. The method according to claim 1, comprising feeding the fluid stream for combination with said polymer solution in a volume ratio of about 1:10 to about 1:100.

17. The method according to claim 1, wherein said mixing comprises homogeneously mixing.

18. The method according to claim 1, wherein the crosslinking agent is provided in the fluid stream as a microcapsule, and wherein the mixing step further comprises shearing the combination of polymer solution and fluid stream to release crosslinking agent from microcapsules into the polymer stream.

19. The method according to claim 1, comprising feeding the fluid stream for combination with said polymer solution in a volume ratio of about 1:10 to about 1:100; wherein the polymer solution comprises polyvinyl alcohol and water as a solvent; wherein the crosslinking agent is selected from the group consisting of aldehydes, aldehyde-containing resins, polyfunctional carboxylic acids, difunctional methacrylates, N-lactam carboxylates, dithiols, dimethyl urea, di-isocyanates, borates, salts of multivalent anions, inorganic polyions, Group 1B salts, polyamide-epichlorohydrin resin, and combinations thereof; and wherein the fluid stream further comprises a glycol.

20. In a method of casting a polymer solution comprising a crosslinking agent onto a substrate for evaporating off a solvent and forming a crosslinked film, the improvement comprising continuously injecting the crosslinking agent into a stream of polymer solution, mixing the resulting stream of polymer solution with the crosslinking agent in-line, and then casting the resulting polymer solution onto a moving substrate to continuously produce the crosslinked film.
